(19) United States
(12) Patent Application Publication
(10) Pub. No.: US 2026/0178692 A1
(43) Pub. Date: Jun. 25, 2026

(54) MIXED-PRECISION MATRIX MULTIPLICATION

(71) Applicant: ADVANCED MICRO DEVICES, INC., Santa Clara, CA (US)

(72) Inventors: Shubra Marwaha, Santa Clara, CA (US); Bin He, Orlando, FL (US); Subramaniam Maiyuran, Folsom, CA (US); Brian Emberling, Palo Alto, CA (US); Ashutosh Garg, Folsom, CA (US)

(21) Appl. No.: 18/999,257

(22) Filed: Dec. 23, 2024

(51) Int. Cl. G06F 17/16

(52) U.S. Cl. CPC G06F 17/16

(57) ABSTRACT

Systems and techniques for providing mixed-precision matrix multiplication in multi-chiplet processors recognize different precision formats of matrices to be multiplied based on, e.g., parameters provided with instructions or start and end memory locations of the matrices. A plurality of different multiplication chains are provided for different formats such that mixed-precision matrix multiplication can be performed using multiplication chains configured to handle multiplication of different precision formats. The multiplication chains are automatically selected based on the precision formats of the matrices to be multiplied, enabling programmers to utilize the chains without having to directly access the individual multiplication chains.

### BACKGROUND

Different precision computing formats, such as FP4 (meaning a 4-bit floating point value), FP6, FP8, and FP16, among others, typically represent numbers using a sign bit, a predetermined number of bits for a mantissa or fraction, and a predetermined number of bits for an exponent. Performing mixed-precision matrix multiplication, that is, multiplication of matrices that store values using different levels of precision where one matrix includes values having a first precision, such as FP6, and a second matrix includes values having a second precision, such as FP4, can be challenging for several reasons. For example, each floating-point format typically has a distinct range of representable values and a particular precision, which can lead to inconsistencies in results when values of different formats are multiplied. When two matrices have values in different precisions or formats, converting between formats is often necessary, which introduces complexity in managing rounding behavior, overflow, and underflow, especially with lower-bit formats like FP4 or FP6, which are prone to rapid loss of precision.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system providing mixed-precision matrix multiplication according to some implementations.

FIG. 2 is a block diagram of a system of mixed-precision matrix multiplication according to some implementations.

FIG. 3 is a flow diagram of a method of mixed-precision matrix multiplication according to some implementations.

### DETAILED DESCRIPTION

Conventional hardware matrix multiplication implementations are typically optimized for uniform precision operations. Mixed-precision operations can complicate the accumulation of partial results during multiplication, potentially introducing errors or inefficiencies that reduce improvements in performance or throughput that might otherwise be realized by using lower-precision arithmetic. For example, lower precision formats can be converted or “upcasted” to a higher precision format, e.g., through software instructions without loss of precision and then multiplied in a uniform precision hardware adder/multiplier, but at the cost of lower performance (increased instructions and lower throughput) and a larger memory footprint. Similarly, a higher precision format can be converted or “downcasted” to a lower precision format but at the cost of loss of precision and performance (e.g., additional instructions that need to be executed).

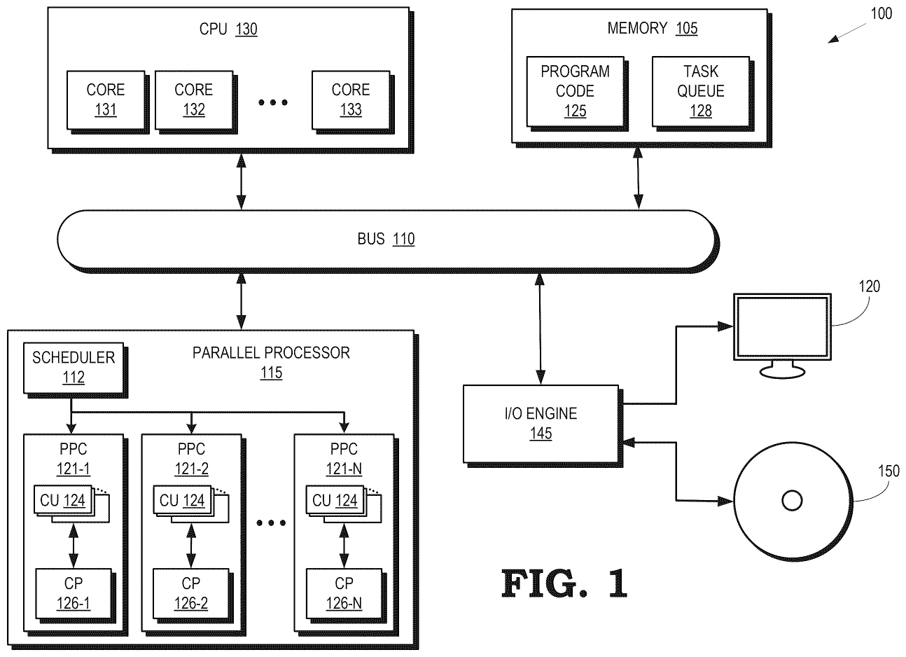

FIGS. 1-3 illustrate systems and techniques for implementing mixed-precision matrix multiplication. By using a combination of hardware and software to perform mixed-precision matrix multiplication, the burden of converting between different precision formats and handling the actual multiplication and accumulation functions that a programmer would often otherwise have to implement manually is significantly reduced. Using the methods disclosed herein, matrices using any of a number of differently formatted values are able to be multiplied efficiently and accurately without requiring programmers to consider many of the factors that may otherwise complicate the multiplication. For example, matrices using FP6 values can be multiplied by matrices using FP8 values, as well as any other precision formats, such as floating-point formats like FP4, FP16, and BF16 and integer formats like I4 and I8. By recognizing the different precision formats to be multiplied in hardware based on, e.g., parameters provided with instructions, and providing a plurality of different multiplication chains (e.g., different sets of multiply and add circuits) for different formats, mixed-precision matrix multiplication can be performed in an efficient and expedient manner.

For example, in some implementations, two or more multiplication chains are configured to handle multiplication of different precision formats automatically as hardware abstraction layers, enabling programmers to utilize the chains without having to directly access the individual multiplication chains. In some implementations, one multiplication chain provides FP4 and FP6 multiplication functionality, another multiplication chain provides FP4, FP6, and FP8 multiplication functionality, and a third multiplication chain provides FP16, BF16, I4, and I8 multiplication functionality. When an instruction to multiply matrices that use FP8 precision formatted values by matrices that use FP4 or FP6 formatted values is executed, for example, the FP4, FP6, and FP8 multiplication chain is automatically utilized to perform the calculations. Similarly, when an instruction to multiply matrices that use FP16 precision formatted values by matrices that use BF16 or I8 formatted values is executed, for example, the FP16, BF16, I4, and I8 multiplication chain is automatically utilized to perform the calculations. However, when an instruction to multiply matrices using FP4 or FP6 formatted values is executed, both the FP4 and FP6 chain and the FP4, FP6, and FP8 multiplication chain are automatically utilized in order to increase throughput and thus the overall speed of the calculations. In this way, lower precision matrices can be multiplied extremely efficiently while still providing ample resources for multiplying matrices that use other precision formats.

FIG. 1 is a block diagram of a processing system 100 providing mixed-precision matrix multiplication according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a multi-chiplet processor, which is implemented in the illustrated example as parallel processor 115, in accordance with some implementations. In some implementations, the parallel processor 115 renders images for presentation on a display 120. For example, the parallel processor 115 renders objects to produce values of pixels that are provided to the display 120, which uses the pixel values to display an image that represents the rendered objects. However, the parallel processor 115 is also capable of executing software not directly involved in any graphics processing pipeline, such as machine learning applications and other advanced computing applications.

In order to provide the parallel processor 115 with the flexibility to execute tasks related to a graphics processing pipeline, machine learning, or other advanced computing applications in an efficient manner, the parallel processor 115 includes a plurality of parallel processing chiplets (PPCs), such as PPCs 121-1, 121-2, and 121-N, which are configured to process tasks and offer one or more of GPU functionality and optimized processing for advanced applications that utilize, e.g., reduced precision data common in machine learning. By providing the parallel processor 115 with a plurality of PPCs 121, the parallel processor 115 is able to perform a number of tasks simultaneously while latency and data transfer energy between the PPCs 121 is minimized. The PPCs 121 are typically implemented using shared hardware resources of the parallel processor 115, such as compute units 124. In some implementations, the PPCs 121 are used to implement shaders, such as geometry shaders, pixel shaders, and the like. Generally, the PPCs 121 are a logical grouping of processing hardware, which in some implementations includes, e.g., one or more processing chiplets, cores, and/or caches. The PPCs 121 typically include or access a number of compute units 124 in the parallel processor 115, and each of the compute units 124 typically includes a number of single-instruction-multiple-data (SIMD) units. The number of PPCs 121 implemented in the parallel processor 115 is a matter of design choice and some implementations of the parallel processor 115 include more or fewer PPCs than are shown in FIG. 1.

In some implementations, the processing system 100 also includes a CPU 130 that is connected to the bus 110 through which it communicates with the parallel processor 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics or other processing by issuing draw calls or other tasks to the parallel processor 115.

In some implementations, as shown in the example of FIG. 1, the PPCs 121 each include a CP 126, such as CPs 126-1, 126-2, and 126-N, to manage and facilitate execution of incoming instructions or tasks. Tasks are stored in a task queue 128 in the memory 105, which also stores dependency information related to the tasks. In some implementations, the task queue 128 is duplicated or instead stored in the parallel processor 115 and/or CPU 130. Generally, the task queue 128 is stored in a location accessible by the CPU 130 and the parallel processor 115 so that the status of the tasks and dependency information in the task queue 128 can be monitored and new tasks and dependency information can be added as needed by, e.g., the CPU 130 or the parallel processor 115. In some implementations, the task queue 128 is implemented as a circular buffer with associated read and write pointers, but in other implementations the task queue 128 takes other forms such as an ordered list or cache.

As shown in FIG. 1, the parallel processor 115 further includes a scheduler 112, which is implemented as any cooperating collection of hardware, software, or a combination thereof that performs functions and computations associated with assigning threads, workgroups, waves, or other tasks, such as compute shader threads, to one or more of the PPCs 121. In some implementations, one or more of the PPCs 121 are able to be selectively addressed or controlled independently from one another or addressed or controlled in groups of two or more such that the parallel processor 115, the scheduler 112, and/or a user is able to control which PPCs 121 perform specific tasks or to distribute tasks across a number of PPCs 121. In some implementations, the parallel processor 115 is used for general purpose computing. The parallel processor 115 executes instructions such as program code 125 stored in the memory 105 based on dependency information stored in the task queue 128, and the parallel processor 115 stores information in the memory 105 such as the results of the executed instructions, new dependency information for tasks, and indications that dependencies have been satisfied, e.g., when tasks associated with dependency information have finished executing.

In some implementations, the scheduler 112 and the CPs 126 work together or in parallel to process tasks and dependency information from the task queue 128. For example, in some implementations, the scheduler 112 assigns tasks to the compute units 124, and the compute units 124 interface with the task queue 128 to determine when tasks can be executed out of order based on dependency information specified in the task queue 128. In some implementations, the scheduler 112 interfaces with the task queue 128 to determine which tasks to assign to the compute units 124 based on the dependency information. Accordingly, in some implementations, the scheduler 112 and compute units 124 work together to ensure maximum parallelization and optimized throughput of task execution in the parallel processor 115.

In some implementations, at least one of the PPCs 121, compute units 124, and/or CPs 126 includes hardware configured to perform mixed-precision matrix multiplication. For example, in some implementations, the hardware includes a plurality of matrix multiplication logic chains, each of which is configured to multiply matrices of up to a certain level of precision. After identifying the precision of matrices to be multiplied, the system 100 of FIG. 1 selects one or more of the matrix multiplication chains based on the identified precision. For example, in some implementations, the processing system 100 multiplies two matrices that each only use 6 bits of precision by utilizing first and second matrix multiplication chains, while multiplying matrices where one of the matrices uses 8 bits of precision only utilizes the second matrix multiplication chain. Providing a number of matrix multiplication chains for matrices having different precisions enables the system 100 and/or programmers to quickly and efficiently multiply matrices having different levels of precision without having to adjust values or otherwise manipulate the input matrices.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the parallel processor 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the parallel processor 115 or the CPU 130.

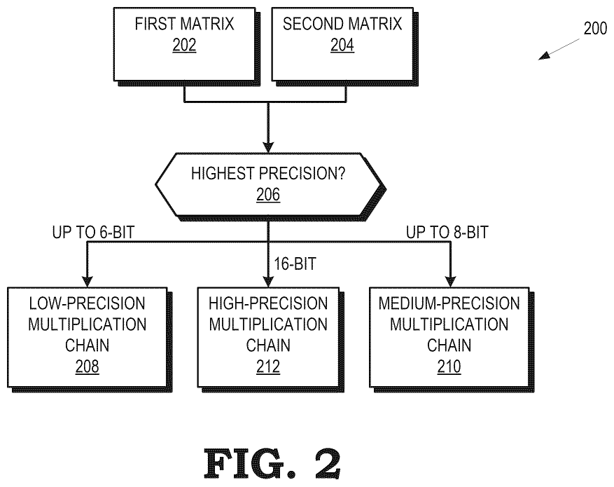

FIG. 2 is a block diagram of a system 200 of mixed-precision matrix multiplication according to some implementations. In some implementations, one or more aspects of the system 200 is executed by at least one of the PPCs 121, compute units 124, and/or CPs 126 of the system 100 of FIG. 1 that includes hardware and/or software configured to select one or more multiplication chains from a plurality of multiplication chains based on a first precision format of a first input matrix and a second precision format of a second input matrix. For example, as shown in FIG. 2, in some implementations, a compute unit 124 receives or retrieves a first matrix, e.g., from memory at block 202 and a second matrix, e.g., from memory at block 204. At block 206, the compute unit 124 identifies the highest precision used by either of the first matrix and the second matrix. In some implementations, the compute unit 124 identifies the highest precision used by the matrices based on, e.g., parameters provided with instructions and/or start and end addresses for each of the matrices. Subsequently, the compute unit 124 selects one or more multiplication chains based on the highest precision one of the first input matrix precision format and the second input matrix precision format.

In some implementations, the compute unit 124 selects two multiplication chains when a highest precision one of the first and second input matrix precision formats is below a threshold number of bits. For example, as shown in FIG. 2, in some implementations, if both matrices have a highest precision format of 6-bits, the compute unit 124 selects a low-precision multiplication chain at block 208 and a medium-precision multiplication chain is selected at block 210. In this way, multiple chains can be utilized simultaneously on different portions of the input matrices in order to increase throughput and overall processing speed. However, if one of the matrices includes an 8-bit precision format, then the compute unit 124 only selects a medium-precision multiplication chain at block 210. Similarly, if one of the matrices includes a 16-bit precision format, then the compute unit 124 selects only a high-precision multiplication chain at block 212. However, in some implementations, all available multiplication chains are selected for lower precision matrix multiplication. For example, in some implementations, matrices using 4- or 6-bit precision formats are multiplied using a low-precision multiplication chain, a medium-precision multiplication chain, and a high-precision multiplication chain by padding or expanding the low-precision formats using known methods to produce higher-precision formats at the compute unit 124. Similarly, in some implementations, up to 8-bit precision formats are multiplied using a medium-precision multiplication chain and a high-precision multiplication chain by padding or expanding the medium-precision formats to produce higher-precision formats. In some implementations, the system 200 produces a 32-bit output value regardless of which multiplication chain or chains are selected.

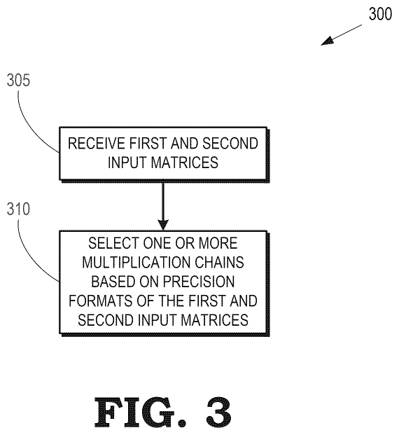

FIG. 3 is a flow diagram of a method 300 of mixed-precision matrix multiplication in multi-chiplet processors, such as the parallel processor 115 of FIG. 1 including a plurality of PPCs 121, according to some implementations. In some implementations, the method 300 is executed by at least one of the PPCs 121, compute units 124, and/or CPs 126 of the system 100 of FIG. 1. At block 305 of the method 300, two input matrices are received or retrieved from memory. At block 310, one or more multiplication chains are selected from a plurality of multiplication chains based on a first precision format of the first input matrix and a second precision format of the second input matrix. In some implementations, a multiplication chain is selected based on a highest precision one of the first input matrix precision format and the second input matrix precision format. In some implementations, a first one of the multiplication chains is configured to perform up to 6-bit matrix multiplication, a second one of the multiplication chains is configured to perform up to 8-bit matrix multiplication, and a third one of the multiplication chains is configured to perform up to 16-bit matrix multiplication. In some implementations, the selected multiplication chain is used to produce a 32-bit value based on the product of the first input matrix and the second input matrix. In some implementations, two multiplication chains are selected when a highest precision one of the first input matrix precision format and the second input matrix precision format is below a threshold number of bits. In some implementations, the threshold number of bits is 6 bits.

In some implementations, the apparatuses and techniques described above are implemented in a system including one or more integrated circuit (IC) devices (also referred to as integrated circuit packages or microchips), such as the parallel processor 115, the PPCs 121, the compute units 124, the CPs 126, and the methods 200 and 300 described above. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An apparatus comprising:
a parallel processor, wherein:
a circuit of the parallel processor is configured to select a multiplication chain from a plurality of multiplication chains based on a first precision format of a first input matrix and a second precision format of a second input matrix.

2. The apparatus of claim 1, wherein the circuit is configured to select a multiplication chain based on a highest precision one of the first input matrix precision format and the second input matrix precision format.

3. The apparatus of claim 1, wherein a first one of the multiplication chains is configured to perform up to 6-bit matrix multiplication.

4. The apparatus of claim 3, wherein a second one of the multiplication chains is configured to perform up to 8-bit matrix multiplication.

5. The apparatus of claim 4, wherein a third one of the multiplication chains is configured to perform up to 16-bit matrix multiplication.

6. The apparatus of claim 1, wherein the selected multiplication chain produces a 32-bit value based on the product of the first input matrix and the second input matrix.

7. The apparatus of claim 1, wherein the circuit is configured to select two multiplication chains when a highest precision one of the first input matrix precision format and the second input matrix precision format is below a threshold number of bits.

8. The apparatus of claim 7, wherein the threshold number of bits is 6 bits.

9. A method, comprising:
receiving a first input matrix and a second input matrix; and
selecting, at a compute unit of a parallel processing chiplet, a multiplication chain from a plurality of multiplication chains based on a first precision format of the first input matrix and a second precision format of the second input matrix.

10. The method of claim 9, further comprising selecting a multiplication chain based on a highest precision one of the first input matrix precision format and the second input matrix precision format.

11. The method of claim 9, wherein a first one of the multiplication chains is configured to perform up to 6-bit matrix multiplication.

12. The method of claim 9, wherein a second one of the multiplication chains is configured to perform up to 8-bit matrix multiplication.

13. The method of claim 9, wherein a third one of the multiplication chains is configured to perform up to 16-bit matrix multiplication.

14. The method of claim 9, further comprising using the selected multiplication chain to produce a 32-bit value based on the product of the first input matrix and the second input matrix.

15. The method of claim 9, further comprising selecting two multiplication chains when a highest precision one of the first input matrix precision format and the second input matrix precision format is below a threshold number of bits.

16. The method of claim 15, wherein the threshold number of bits is 6 bits.

17. A system comprising:
a memory configured to store a first input matrix and a second input matrix; and
a circuit configured to select a multiplication chain from a plurality of multiplication chains based on a first precision format of the first input matrix and a second precision format of the second input matrix.

18. The system of claim 17, wherein the circuit is configured to select a multiplication chain based on a highest precision one of the first input matrix precision format and the second input matrix precision format.

19. The system of claim 17, wherein the selected multiplication chain is configured to produce a 32-bit value based on the product of the first input matrix and the second input matrix.

20. The system of claim 17, wherein the circuit is configured to select two multiplication chains when a highest precision one of the first input matrix precision format and the second input matrix precision format is below a threshold number of bits.
